(19) United States
(12) Patent Application Publication
(10) Pub. No.: US 2008/0296968 A1
(43) Pub. Date: Dec. 4, 2008

(54) Electric trailer brake controller with an adjustable accelerometer mounting

(75) Inventor: Jeffery S. Culbert, Albertville, AL (US)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: Hayes Brake Controller Company, LLC

(21) Appl. No.: 11/807,720

(22) Filed: May 30, 2007

(51) Int. Cl. B60T 13/74; B60T 8/32

(52) U.S. Cl. 303/20; 303/24.1

(57) ABSTRACT

An accelerometer is mounted upon a movable base member that is disposed within an electric brake controller housing with a lever attached to the moveable base, the lever being external to the brake controller housing to allow orientation of the accelerometer within the housing.

### CROSS-REFERENCE TO RELATED APPLICATIONS

Not applicable.

### BACKGROUND OF THE INVENTION

This invention relates in general to controllers for electric wheel brakes used on trailers and in particular to an improved controller for such electric wheel brake controllers.

Towed vehicles, such as recreational and utility trailers that are towed by automobiles and small trucks, are commonly provided with electric wheel brakes. Each of the electric wheel brakes generally includes a pair of brake shoes which, when actuated, frictionally engage a brake drum. An electromagnet is mounted on one end of a lever to actuate the brake shoes. When an electric current is applied to the electromagnet, the electromagnet is drawn against the rotating brake drum which pivots the lever to actuate the brakes. Typically, the braking force produced by the brake shoes is proportional to the electric current applied to the electromagnet. This electric current can be relatively large. For example, the electric wheel brakes on a two wheeled trailer can draw six amperes of current when actuated and the electric wheel brakes on a four wheeled trailer can draw 12 amperes of current.

Automotive industry standards require that electrically-actuated vehicle wheel brakes be driven against the ground potential of the vehicle power supply. Accordingly, one end of each of the towed vehicle wheel brake electromagnets is electrically connected to the towed vehicle ground and the towed vehicle ground is electrically connected to the towing vehicle ground. The other end of each of the wheel brake electromagnets is electrically connected through an electric wheel brake controller to the towing vehicle power supply.

Various electric brake controllers for towed vehicle electric brakes are known in the art. For example, a variable resistor, such as a rheostat, can be connected between the towing vehicle power supply and the brake electromagnets. Such an actuator is disclosed in U.S. Pat. No. 3,740,691. The towing vehicle operator manually adjusts the variable resistor setting to vary the amount of current supplied to the brake electromagnets and thereby control the amount of braking force developed by the towed vehicle wheel brakes.

It also is known to include an integrating circuit in an electric wheel brake controller. When the towing vehicle brakes are applied, a signal is sent to the integrating circuit. The integrating circuit generates a continually increasing voltage which is applied to the electric wheel brakes. The longer the towing vehicle brakes are applied, the more brake torque is generated by the electric wheel brakes. A manually adjustable resistor typically controls the rate of integration. One such actuator is disclosed in U.S. Pat. No. 3,738,710.

Also known in the art are more sophisticated electric wheel brake controllers which include electronic circuitry to automatically supply current to the towed vehicle brake electromagnets that is proportional to the towing vehicle deceleration when the towing vehicle brakes are applied. Such electronic wheel brake controllers typically include a deceleration sensing unit that automatically generates a brake control signal corresponding to the desired braking effort. For example, the sensing unit can include a pendulum which is displaced from a rest position when the towing vehicle decelerates and an electronic circuit which generates a brake control signal that is proportional to the amount of pendulum displacement. One such unit is disclosed in U.S. Pat. No. 4,721,344. Alternately, the hydraulic pressure in the towing vehicle's braking system or the pressure applied by the vehicle operator's foot to the towing vehicle's brake pedal can be sensed to generate the brake control signal. An example of a controller which senses the towing vehicle brake pressure to generate the brake control signal is disclosed in U.S. Pat. No. 4,398,252 while an example of a controller that utilizes a pressure pad mounted upon a brake pedal is disclosed in U.S. Pat. No. 3,574,414. More recently, multi-axis accelerometers have been mounted within brake controllers and utilized to generate the brake control signal. An example of such a multi-axis accelerometer is disclosed in Published US Patent Application No. 2005/0127747.

Known electronic wheel brake controllers also usually include an analog pulse width modulator. The input of the pulse width modulator is electrically connected to the deceleration sensing unit and receives the brake control signal therefrom. The pulse width modulator is responsive to the brake control signal to generate an output signal comprising a fixed frequency pulse train. The pulse width modulator varies the duty cycle of the pulse train in direct proportion to the magnitude of the brake control signal. Thus, the duty cycle of the pulse train corresponds to the amount of braking effort desired.

Electronic wheel brake controllers further include an output stage which is electrically connected to the output of the pulse width modulator. The output stage typically has one or more power transistors which are connected between the towing vehicle power supply and the towed vehicle brake electromagnets. The power transistors, which are usually Field Effect Transistors (FET's), function as an electronic switch for supplying electric current to the towed vehicle brakes. The output stage may also include a driver circuit which electrically couples the output of the pulse width modulator to the gates of the FET's.

The output stage is responsive to the pulse width modulator output signal to switch the power transistors between conducting, or “on”, and non-conducting, or “off”, states. As the output transistors are switched between their on and off states in response to the modulator output signal, the brake current is divided into a series of pulses. The power supplied to the towed vehicle brakes and the resulting level of brake application are directly proportional to the duty cycle of the modulator generated output signal.

It is also known to include a manual override control with electronic wheel brake controllers. Such manual override controls typically include a potentiometer that is actuated by a sliding control lever or pushbutton that is moved by the vehicle driver. The potentiometer provides a manual brake control signal to the input of the analog pulse width modulator. The controllers are usually designed to discriminate between the manual brake control signal and the brake control signal supplied by the sensing unit and to respond to the greater signal.

As described above, rather sophisticated known controllers for electric trailer brakes have been developed. However, the controllers require accurate brake control signals for optimal operation. The use of accelerometers provides consistent brake control signals, but, due to variable mounting angles for the controller within the towing vehicle, the accelerometer output typically must be compensated for gravity effects. For example, if a brake controller equipped with an accelerometer is mounted with the axis of the accelerometer in a non-horizontal position, the force of gravity will exert a continuous basis upon the brake control signal generated by the accelerometer. As a result, compensation must be provided. Such compensation may be provided by including a second accelerometer that is positioned perpendicular to the first accelerometer. An algorithm is then utilized to combine the output signals of both accelerometers to generate a compensated brake control signal. However, such an approach adds to the complexity and cost of the brake controller. Accordingly, it would be desirable to provide a simple compensation device for non-horizontally mounted brake controllers.

### SUMMARY OF THE INVENTION

This invention relates to an improved controller for electric wheel brakes of towed vehicles.

The present invention contemplates a device for sensing the deceleration of a vehicle that includes a support member adapted to be secured to the vehicle, the support member including a pair of spaced apart support arms that define an open space therebetween. The device also includes a base member disposed between the support member arms within the open space with the base member being pivotable about an axis. The device further includes at least one accelerometer mounted upon the base member and a positioning device carried by the base member that is operable to rotate the base member relative to the support member such that the accelerometer is oriented relative to its surroundings. The present invention also contemplates that the device for sensing deceleration is mounted within a controller for electric trailer brakes and is operative to generate a brake control signal that is proportional to the deceleration of the vehicle.

The present invention further contemplates a method for mounting the above electric brake controller that includes the steps of mounting the brake controller upon a towing vehicle and positioning the towing vehicle upon a horizontal surface. The positioning device is then oriented to place the accelerometer in a horizontal position.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a FIG. 1 is a schematic circuit drawing of a brake controller that is in accordance with the present invention.

FIG. 2 is circuit diagram for the brake controller shown in FIG. 1.

FIG. 3 is a perspective view for an adjustable accelerometer support member that is utilized in the brake controller shown in FIG. 1.

FIG. 4 is another perspective view of the support member shown in FIG. 3.

FIG. 5 is a sectional view of the support member shown in FIG. 3 taken along line 5-5 that illustrates the operation of the support member.

### DETAILED DESCRIPTION OF THE PREFERRED EMBODIMENT

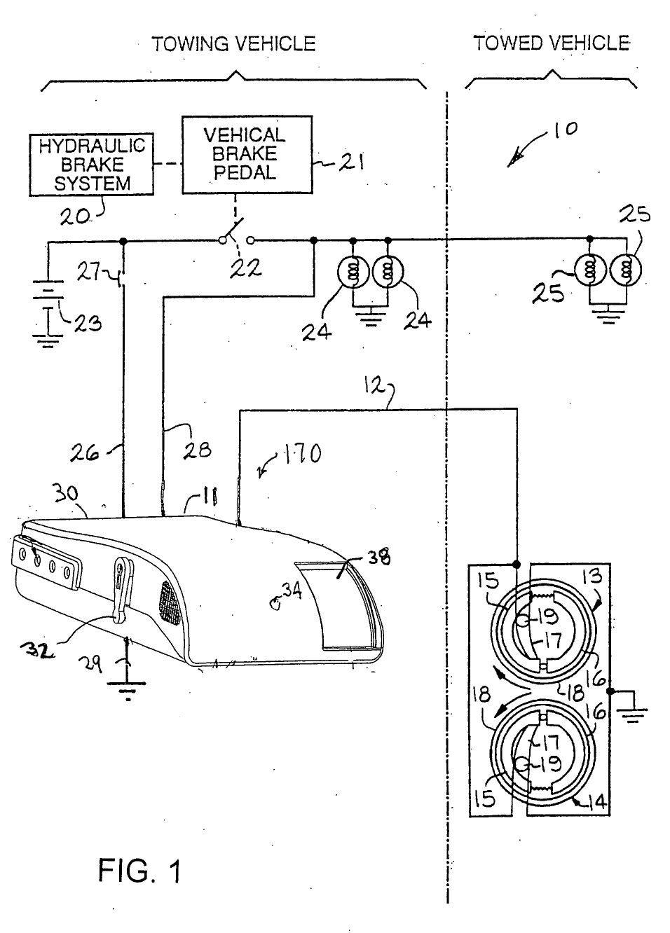

Referring now to the drawings, there is illustrated in FIG. 1 a schematic diagram illustrating an electric brake system 10 for a towed vehicle (not shown) which utilizes an electronic brake controller 11 embodying the principles of the present invention. The brake controller 11 is typically located in a towing vehicle (not shown), usually being mounted beneath the towing vehicle dashboard. When actuated, the controller 11 functions to supply an electric current through a first line 12 to energize electric wheel brakes 13 and 14 which brake the wheels of the towed vehicle (not shown).

The electric wheel brakes 13 and 14 each include a pair of brake shoes 15 and 16 which, when actuated by a lever 17, are expanded into contact with a brake drum 18 for braking the wheels of the towed vehicle. A separate electromagnet 19 is mounted on an end of each of the brake actuating levers 17. Each electromagnet 19 is positioned to abut the generally flat side of the brake drum 18. As an electric current is passed through each of the electromagnets 19, the electromagnets 19 are drawn into contact with the brake drums 18 and the resulting drag pivots the levers 17 to engage the brake shoes 15 and 16 in a conventional manner. It will be appreciated that, while FIG. 1 shows two sets of electric wheel brakes 13 and 14, the invention also can be applied to towed vehicles having more than two sets of wheel brakes.

The towing vehicle typically includes a conventional hydraulic brake system 20 which is actuated when a brake pedal 21 is depressed by a vehicle driver. The brake pedal 21 is coupled to a brake light switch 22. When the brake pedal 21 is depressed, the brake light switch 22 is closed and power from a vehicle power supply 23, shown as a storage battery in FIG. 1, is supplied to one or more towing vehicle brake lights 24 and one or more towed vehicle brake lights 25. The vehicle power supply 23 is also connected by a second line 26 through a circuit breaker 27 to the controller 11. Power is continuously supplied to the controller 11 through the second line 26. It will be appreciated that, while a circuit breaker 27 is shown in FIG. 1, a fuse or other over-current protection device can be used. A third line 28 connects the brake light side of the brake light switch 22 to the controller 11. Thus, power also is supplied through the third line 28 to the controller 11 when the brake light switch 22 is closed. The controller is connected to the towing vehicle ground by a fourth line 29.

The controller 11 includes a housing 30 having a leveling lever 32 extending from one side. The function of the leveling lever 32 will be explained below. A diode 34 that lights when the trailer brakes are actuated is carried upon the front surface of the controller housing 30. In some instances, it may be desirable to actuate only the towed vehicle brakes 13 and 14. This may be desirable, for example, to stabilize the towed vehicle against oscillations or swinging caused by strong side winds. Therefore, the brake controller 11 also includes a manual mode of operation. Accordingly, a manual slide lever 38 is provided on the electronic controller 11 to allow the vehicle driver to actuate the towed vehicle brakes 13 and 14 without applying the towing vehicle brakes. Moving the manual slide lever 38 to the left in FIG. 1 initiates the manual mode of operation. The amount of electric current supplied to the towed vehicle wheel brakes 13 and 14 is proportional to the displacement of the manual slide lever 38. If the manual slide lever 38 is moved while the brake pedal 21 is depressed, the manual operating mode overrides the automatic operating mode.

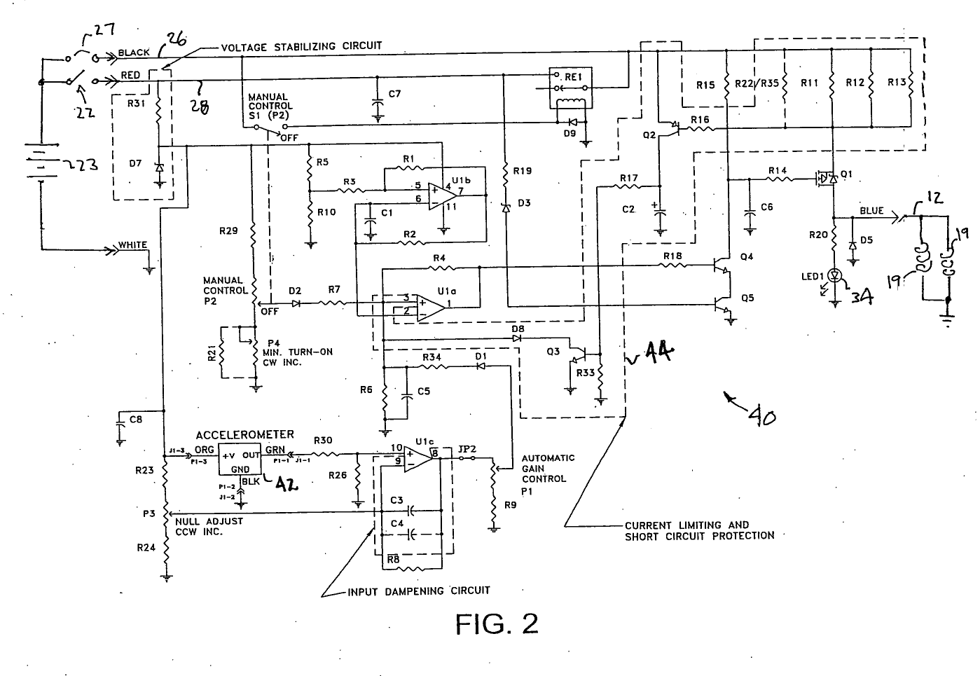

The electrical circuit 40 of the controller 11 is shown in FIG. 2 where components that are similar to components shown in FIG. 1 have the same numerical designators. The circuit 40 includes an accelerometer 42 that generates a brake control signal which is proportional to the deceleration of the towing vehicle. The brake control signal passes through an input operational amplifier U1c and is applied to the positive input terminal of a first operational amplifier U1a. The first operational amplifier U1a cooperates with a second operational amplifier U1b to generate a Pulse Width Modulated (PWM) output signal having a constant frequency and a variable duty cycle that is proportional to the magnitude of the brake control signal.

The PWM output signal is applied to the base of a driver transistor Q4 that is connected to both the power supply 23 and the gate terminal of a power Field Effect Transistor (FET) Q1 while the power FET Q1 is connected between the power supply 23 and the wheel brake electromagnets 19. The driver transistor Q4 is responsive to the PWM output signal to switch the power FET Q1 between its non-conducting and conducting states with the duration of the conducting states being proportional to the PWM duty cycle. If the power FET Q1 remains in its conducting state for a longer portion of each switching cycle, the average current supplied to the brake electromagnets 19 increases. Thus, the magnitude of the current supplied to the brake electromagnets 19 increases as a function of the magnitude of the brake control signal.

As shown in FIG. 2, the controller 40 also includes an output current limiter and short circuit protection circuit 44. The current limiter and protection circuit 44 monitors the current flowing through the power FET Q1. The protection circuit 44 is operable to cause the first operational amplifier U1a to reduce the duty cycle of the PWM output signal applied to the base of the driver transistor Q4 if the current supplied to the wheel brake electromagnets 19 increases above a predetermined first threshold. The protection circuit 44 is further operable to turn off the power FET Q1 if the wheel brake current exceeds a second predetermined threshold.

The controller circuit 40 also includes a zener diode, labeled D7, that is connected between the voltage supply 23 and ground. The zener diode D7 functions to regulate the voltage supplied to the second operational amplifier U1b and thus prevent overloading the operational amplifier while assuring consistent operation thereof. The circuit 40 further includes a damping capacitor C3 which is connected across the input operational amplifier U1c. The damping capacitor C3 slows changes in the accelerometer generated brake control signal to prevent false brake applications caused by spurious accelerometer output signals that are due road surface irregularities. Damping can be further increased by connecting an optional second damping capacitor C4 in parallel to the damping capacitor C3, as shown at the bottom of FIG. 2 with dashed connecting lines.

The controller 11 also includes a manual brake control which can be used by the towing vehicle operator to apply the trailer brakes independently of the towing vehicle brakes. The manual brake control includes a potentiometer P2 that is connected between the power supply 23 and ground and has a slider connected to the manual slide lever 38 shown in FIG. 1. The slider tap of the potentiometer P2 is connected to the positive input terminal of the first operational amplifier U1a. Movement of the potentiometer P2 from its “OFF” position generates a manual brake control signal which is applied to the first operational amplifier U1a. The potentiometer P2 includes a return spring which urges the potentiometer slider to the OFF position when the slide lever 38 is released.

As also shown in FIG. 2, the manual brake control signal potentiometer P2 is ganged to a manual control potentiometer switch S1. When the towing vehicle operator manually moves the manual slide lever 38 to displace the potentiometer slider from the OFF position, the switch S1 is closed. One side of the switch S1 is connected to the vehicle power supply 23 while the normally open contact of the switch S1 is connected through the coil of a relay RE1 to ground. The relay RE1 includes a set of normally open contacts having a common tap connected to the power supply 23. The normally open contact of the switch S1 is connected to the non-powered side of the brake light switch 22. Thus, when the vehicle operator moves the manual slide lever 38, the ganged switch closes the contacts in the relay RE1 to supply power to the brake controller 11 though line 28. Accordingly, the brake controller 11 becomes operational when the slider lever 38 is moved, even though the towing vehicle brake pedal is not depressed, allowing the vehicle operator to actuate the trailer brakes independently of the towing vehicle brakes. Additional details of the controller circuit 40 are included in U.S. Pat. Nos. 6,325,466 and 6,655,752, which are incorporated herein by reference.

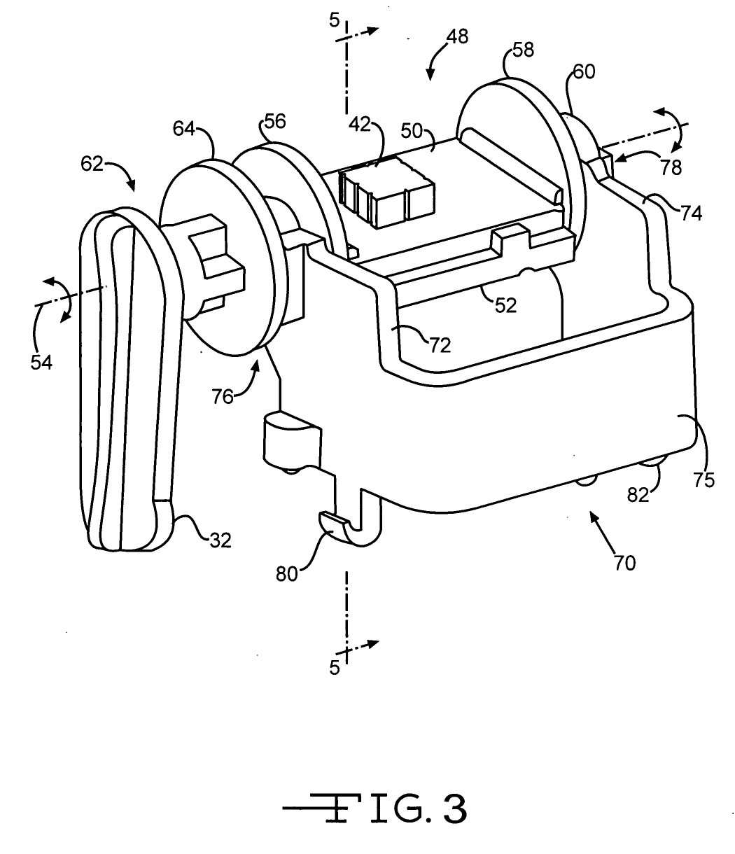

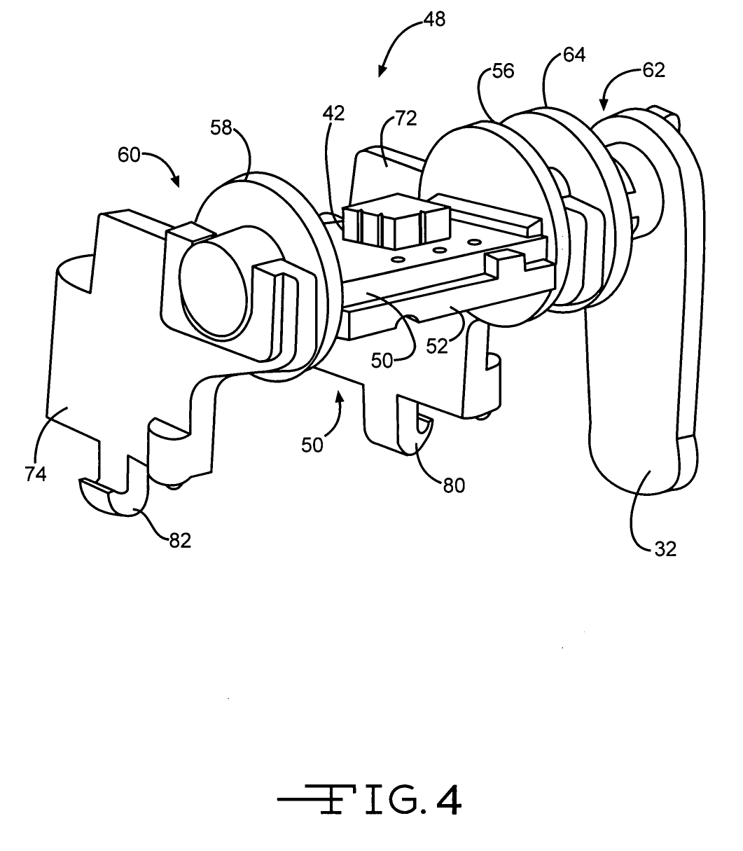

The present invention contemplates an accelerometer mounting assembly 48 that includes the accelerometer 42 mounted upon a circuit substrate 50 that is carried by a generally rectangular shaped base member 52, as shown in FIGS. 3 and 4. While the accelerometer 42 is shown in the figures as being mounted upon a circuit substrate 50, it will be appreciated that the invention also may be practiced with the accelerometer mounted directly upon the base member 52 (not shown). The base member 52 is rotatable about a central axis 54, as illustrated by the small double headed arrows in FIG. 3. Alternately, the accelerometer 42 may be mounted upon a circuit substrate (not shown) that is carried by the base member 52. A pair of flanges 56 and 58 that are formed upon opposite ends of the base member 52 function to provide protection for the accelerometer 42. As best seen in FIG. 4, a short support shaft 60 extends from one end of the base member 52, while, as best seen in FIG. 3, a longer support shaft 62 extends from the opposite end of the base member 52 and has sufficient length to pass through an aperture formed in the side of the controller housing 30. A second flange 64 is formed upon the longer shaft 62 to provide a seal for the aperture formed in the side of the controller housing 30. The end of the longer shaft 62 carries the leveling lever 32.

The base 52 member is carried by a U-shaped support member 70 having a pair of spaced apart support arms 72 and 74 that extend from a cross member 75, as shown in FIGS. 3 and 4. Each of the support arms 72 and 74 has a circular aperture 76 and 78, respectively, formed therethrough. As best seen in FIG. 4, the apertures 76 and 78 intersect the upper edges of the arms 72 and 74 to form openings such that the shafts 60 and 62 formed upon the ends of the base member 52 may be inserted through the openings and snapped into and retained within the apertures 76 and 78. The edges of the apertures 76 and 78 frictionally engage the shafts 60 and 62 to retain the base member 52 between the support arms 72 and 74 in a selected rotational orientation with respect to the support member 70. A pair of hooked tabs 80 and 82 extend from the lower edges of the support arms 72 and 74. The hooked tabs 80 and 82 snap into corresponding apertures formed through a Printed Circuit Board (PCB) 86 that carries the controller circuit 40 and thereby secure the bracket 58 to the PCB. The PCB 86 is disposed within the controller housing 30. Alternately, a pair of stakes (not shown) may be formed extending from the bottom of the arms 72 and 74. The stakes would be received by corresponding apertures formed through the PCB 86 with the ends of the stakes glued to the PCB. Alternately, the ends of the stakes may be heated and then peened against the bottom surface of the PCB.

A plurality of wires (not shown) extend from electronic components carried upon the PCB 86 to the accelerometer 42. The invention also contemplates mounting a signal conditioning circuit (not shown) upon the circuit substrate 50. The signal conditioning circuit functions to modify the output signal generated by the accelerometer 42 and would have input ports connected to the accelerometer 42 and output ports connected to electronic components carried by the PCB 86. Alternately, the signal conditioning circuit may mounted upon the PCB 86.

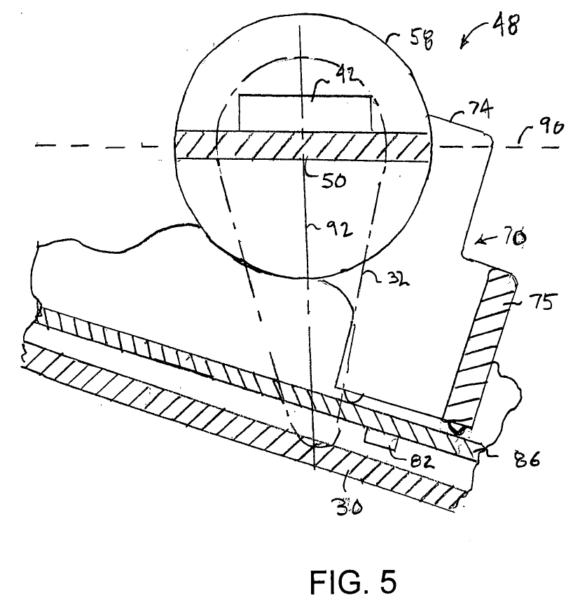

The operation of the accelerometer mounting assembly 60 will now be described in light of FIG. 5, which is a partial sectional view of the brake controller 11 in a typical mounting position upon a vehicle dashboard (not shown). In FIG. 5, the dashed line labeled 90 represents a horizontal plane. Typically, the brake controller 11 is mounted upon, or under, the towing vehicle dashboard with the controller aligned with the vehicle longitudinal axis. Due to the shape of the vehicle dashboard, the mounting surface usually is not parallel to the horizontal plane 90. With prior art brake controllers that utilize an accelerometer to generate the brake control signal, a non-horizontal mounting introduces a basis into the brake control signal that is due to the force of gravity. Accordingly, some method of compensation is required for such prior art controllers in order to obtain a true brake control signal, such as providing a second accelerometer and a signal compensation algorithm. However, with the present invention, the orientation of the accelerometer 42 may be correctly placed in the proper horizontal position by moving the leveling lever 32 of the installed controller to a vertical position, as shown in phantom in FIG. 5 and by the leveling lever axis of symmetry 92 that is perpendicular to the horizontal plane 90. Once the leveling lever 32 is placed into a vertical position, the accelerometer 44, which is mounted in a plane that is perpendicular to the leveling lever 32, is automatically placed in a horizontal position. As described above, the frictional engagement of the shafts 60 and 62 with the edges of the arm apertures 76 and 78 to maintain the base member 52 and the accelerometer 42 in the horizontal position.

In another embodiment of the invention, the controller 11 includes a feedback device to assist the operator in leveling the accelerometer 42 and the base member 52 after the controller 11 is installed in the towing vehicle. The feedback device includes a leveling diode (not shown) that is mounted upon the front surface of the controller housing 30 and that illuminates when the accelerometer 42 is level. To level the accelerometer, the towing vehicle is parked upon a horizontal surface. As explained above, when the accelerometer 42 is not level, the force of gravity will cause the accelerometer to generate a brake control signal. Conversely, the gravity brake control signal will go to zero when the accelerometer 42 is horizontal. Therefore, the embodiment with leveling feedback includes a circuit (not shown) that monitors the brake control signal and illuminates the leveling diode only when the accelerometer is horizontal, as indicated by the accelerometer output signal going to zero. Accordingly, once the vehicle is positioned upon a horizontal surface, it is only necessary for the towing vehicle operator to move the leveling arm 32 until the leveling diode illuminates, signaling that the accelerometer 42 has been placed into position that is parallel to the horizontal surface. The feedback device may also include a pushbutton that activates and deactivates the feedback circuit. With provision of such a pushbutton, the circuit may be selectively activated to avoid any possible confusion that may be caused by the leveling diode flashing on and off, as may occur upon encountering grades. Alternately, the feedback circuit may also be implemented to illuminate the feedback diode when the accelerometer is not in a horizontal position and to extinguish the illumination when the accelerometer is in a horizontal position.

By physically orienting the accelerometer 42 within a horizontal plane, the present invention obviates any need to provide any brake controller orientation compensation device and/or algorithm for the brake control signal. Such compensation may require a multi-axis accelerometer with multiple outputs to determine the brake signal compensation. Instead, the present invention may be utilized with a single axis accelerometer, which would be less costly than a multi-axis accelerometer. Nevertheless, it is contemplated that the present invention may also be practiced with a multi-axis accelerometer that has each accelerometer orthogonally oriented with respect to the other accelerometers. Indeed, if it is desired to provide a two axis accelerometer to monitor both longitudinal and vertical accelerations of a vehicle, the present invention will provide for the correct orientation of both sensors, since the alignment and leveling of the longitudinal accelerometer will automatically align the vertical accelerometer. Therefore, use of the present invention obviates any need to compensate the vertical acceleration signal. Additionally, for a sensor including three orthogonally oriented accelerometers, it would only be necessary to mount the controller with the longitudinal accelerometer axis parallel to the longitudinal axis of the towing vehicle to provide alignment with a third lateral accelerometer. Also, as the cost of accelerometers continues to decrease, the present invention may be practiced with a multi-axis accelerometer with only the accelerometer that monitors longitudinal movement connected to the brake controller circuit 40. Any other accelerometers would simply not be connected to the brake controller circuit 40. Thus, the same circuit may be utilized with any number of commercially available accelerometers. However, the invention also contemplates connecting the other unused accelerometers to other towing vehicle systems (not shown), such as, for example, a vehicle stability control system.

In another embodiment of the invention, the leveling lever 32 is replaced by a knob (not shown) with appropriate markings to allow leveling of the base member 52 and accelerometer 42 within the controller housing 30.

It will be appreciated that the brake controller circuit 40 shown in FIG. 2 is intended to be exemplary and that the present invention also may be practiced with brake controller circuits other than the one shown in FIG. 2. Other such circuits may include, for example, microprocessor based electric brake controller circuits (not shown), such as the one shown in U.S. Pat. No. 5,616,930, which is incorporated herein by reference. The brake controllers also may include a display and pushbuttons (not shown) for setting controller parameters, and hand held remote control units as described in Published US Patent Application No. 2005/0127747, which also is incorporated herein by reference.

Additionally, the controller may also be provided with an optional hand held manual remote switch (not shown) that is connected to the controller by a cable having quick disconnect connectors at each end. The manual remote control includes a pushbutton that can be used to initiate the manual mode of operation. Upon pressing the pushbutton, the manual remote control functions the same as the manual switch 38 described above to actuate the towed vehicle brakes with the applied braking force being proportional to the displacement of the pushbutton. Such a remote manual control is described in U.S. Pat. No. 6,557,952, which is incorporated herein by reference. When either the manual slide lever 38 or the manual remote control pushbutton are pressed, the towing vehicle and towed vehicle brake lights 24 and 25 are illuminated.

While the invention has been described and illustrated above for use with an electric brake controller, it will be appreciated that the invention may also be practiced with other systems. Thus the invention may include either a vertical or a lateral accelerometer that is carried by the mounting assembly 48 (not shown). The lever would then be used to orient the accelerometer parallel to a vertical or lateral vehicle axis, respectively. The accelerometer would be electrically connected to a vehicle system needing a vertical or lateral acceleration signal.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A device for sensing the deceleration of a vehicle comprising:
a support member adapted to be secured to the vehicle, said support member including a pair of spaced apart support arms that define an open space therebetween;
a base member disposed between said support member arms within said open space, said base member being pivotable about an axis;
at least one accelerometer mounted upon said base member; and
a positioning device connected to said base member, said positioning device operable to rotate said base member relative to said base member, whereby said accelerometer is oriented relative to the surroundings.

2. The device according to claim 1 wherein a pair of shafts are formed upon the opposite ends of said base member and further wherein an aperture is formed in each of said support arms, each of said support arm apertures receiving retaining one of said base member shafts whereby said support member is disposed between said support arms.

3. The device according to claim 2 wherein said apertures have edges that frictionally engage said shafts to maintain said base member in its orientation relative to said arms.

4. The device according to claim 3 wherein said accelerometer has a principal axis and further wherein said base member and said accelerometer are oriented in a horizontal plane with said accelerometer principle axis parallel to a longitudinal axis of the vehicle.

5. The device according to claim 4 wherein the device is disposed within an electric brake controller housing and further wherein said accelerometer is connected to an electric brake controller circuit, said accelerometer being operative to generate a brake control signal that is supplied to said brake controller circuit, said brake control signal being proportional to the deceleration of a vehicle upon which said electric brake controller housing is mounted.

6. The device according to claim 5 wherein said brake controller circuit is responsive to said brake control signal to generate an output signal for actuation of a towed vehicle electric wheel brakes.

7. The device according to claim 7 further including a signal conditioning circuit carried by said base member, said signal conditioning circuit electrically connected between said accelerometer and said electric brake control circuit and operative to modify said brake control signal generated by said accelerometer.

8. The device according to claim 5 where in one of said shafts is extended to pass through an aperture formed in said electronic brake controller housing and further wherein said positioning device is mounted upon an end of said extended shaft to permit the base member to be rotated sufficiently to place said accelerometer in said horizontal position.

9. The device according to claim 8 wherein at least one hooked tab is formed upon one of said support arms, said hooked tab adapted to secure said support member to a circuit substrate that is disposed within said brake controller housing.

10. The device according to claim 8 further including at least one flange formed upon one of said shafts.

11. The device according to claim 8 wherein said leveling device is a leveling lever.

12. The device according to claim 8 further including a leveling circuit connected to said accelerometer, said leveling circuit operative to provide an indication to a vehicle operator that said base member has been rotated sufficiently to place said accelerometer in said horizontal position.

13. The device according to claim 12 wherein said leveling circuit includes a light emitting diode that is illuminated when said accelerometer is placed in said horizontal position.

14. A method for mounting an electric brake controller comprising the steps of:
(a) providing a brake controller having a housing, the brake controller including an accelerometer mounted upon an adjustable base member that is disposed within the brake controller housing, the base member having an accessible positioning device that is operative to rotate the accelerometer relative to the brake controller housing;
(b) mounting the brake controller upon a towing vehicle;
(c) positioning the towing vehicle upon a horizontal surface; and
(d) manipulating the positioning device to orient the accelerometer in a horizontal position.

15. The method according to claim 14 wherein the accelerometer provide in step (a) includes a principle axis and further wherein step (b) includes mounting the brake controller within the towing vehicle with the accelerometer principle axis parallel the towing vehicle longitudinal axis.

16. The method according to claim 14 wherein the positioning device provided in step (a) includes a lever that is mounted outside of the brake controller housing and is connected to the base member whereby movement of the leveling lever rotates the base member with in the housing to orient the accelerometer in the horizontal position.
